(19) United States
(12) Patent Application Publication
(10) Pub. No.: US 2011/0233966 A1
(43) Pub. Date: Sep. 29, 2011

(54) AUTOMOBILE COLUMN

(75) Inventors: Markus Pellmann, Sassenberg (DE); Martin Pohl, Altenbeken (DE); Martin Schroeter, Paderborn (DE); Stefan Adelbert, Delbruck (DE); Otto Buschsieweke, Paderborn (DE); Christian Handing, Langenberg (DE)

(73) Assignee: Benteler Automobiltechnik GmbH, Paderborn (DE)

(21) Appl. No.: 13/069,537

(22) Filed: Mar. 23, 2011

(30) Foreign Application Priority Data
Mar. 25, 2010 (DE) 10 2010 012 832.5

(51) Int. Cl. B62D 25/04

(52) U.S. Cl. 296/193.06

(57) ABSTRACT

An automobile column, for example an A-column, a B-column, a C-column and/or a D-column, is made of sheet steel. The automobile column has a first region which underwent heat treatment, a second region which is not heat-treated, and a transition zone between the first and second regions. The transition zone is hereby defined by a width which is smaller than or equal to 50 mm.

### CROSS-REFERENCES TO RELATED APPLICATIONS

This application claims the priority of German Patent Application, Serial No. 10 2010 012 832.5-56, filed Mar. 25, 2010, pursuant to 35 U.S.C. 119(a)-(d), the content of which is incorporated herein by reference in its entirety as if fully set forth herein.

This is one of five applications all filed on the same day. These applications deal with related inventions. They are commonly owned and have the same inventive entity. These applications are unique, but incorporate the others by reference. Accordingly, the following U.S. patent applications are hereby expressly incorporated by reference: “CROSS MEMBER”, representative's docket no.: PELLMANN-2; “SIDE RAIL”, representative's docket no.: PELLMANN-3; “TRANSMISSION TUNNEL”, representative's docket no.: PELLMANN-4″; and “METHOD FOR PRODUCING A MOTOR VEHICLE COMPONENT, AND A BODY COMPONENT”, representative's docket no.: PELLMANN-6.

### BACKGROUND OF THE INVENTION

The present invention relates to an automobile column for installation in a motor vehicle.

It would be desirable and advantageous to provide an improved column for installation in a motor vehicle which obviates prior art shortcomings and can be produced at low cost in industrial-scale production while still being reliable in operation.

### SUMMARY OF THE INVENTION

According to one aspect of the present invention, an automobile column, in particular an A-column, a B-column, a C-column and/or a D-column, is constructed of a steel sheet blank and has a first region which underwent heat treatment, a second region which is not heat-treated, and a transition zone between the first and second regions, said transition zone defined by a width which is smaller than or equal to 50 mm.

In accordance with the present invention, the material property in certain regions of the automobile column of the invention can be produced with a reliable process and with desired characteristics. After hot-forming and press-hardening of a steel sheet blank made from high-strength hardenable steel, the automobile column is post-treated with a targeted partial heat treatment. By the partial heat treatment below the austenitic transition temperature, ductile material structures are produced in the heat-treated regions of the automobile column.

Advantageously, an intentional deformation is facilitated in the event of a crash in the intentionally heat-treated regions, without causing formation of cracks or tears in these regions. This increases the energy dissipation capability of the automobile column while retaining high stiffness. Subsequently, considerable energy is absorbed in an automobile equipped with an automobile column according to the invention by converting kinetic impact energy into deformation energy, while maintaining the high stiffness of the passenger compartment.

In another advantageous embodiment of the present invention, the width of the transition zone may be less than 30 mm, suitably less than 20 mm. Within the context of the present invention, the transition zone from a heat-treated region to a non-heat-treated region is comparable to a zone affected by heat from a weld seam. Moreover, the material structure is changed in the transition zone which is not necessarily desirable.

Advantageously, a transition zone with small geometric dimensions may be produced in the automobile column according to the invention. Advantageously, a transition zone of less than 15 mm can be realized on the automobile column. Accordingly, those regions on the individual components, in particular on the automobile column, which are designed to deform in the event of a crash and those regions which can essentially retain their shape in the event of a crash, can already be designated during the manufacture of a crash-optimized motor vehicle chassis.

According to another advantageous feature of the present invention, the width of the heat-treated region may correspond to 0.2-times to 3.0-times the width and/or the height of the heat-treated region. In relation to the distribution of the total stress inside the component, a particularly advantageous embodiment for the crash and stiffness structure of the motor vehicle chassis is attained.

Advantageously, joining flanges may be partially heat-treated. For example, in an integral body-frame chassis, the heat-treated region, in particular embodied as joining flange, has advantageous properties for the stiffness of the chassis in a crash. Within the context of the invention, an automobile column refers to an A-column, a B-column, a C-column and/or a D-column of a motor vehicle. A joining flange of an automobile column is a region that is coupled with other components. For example, a joining flange refers to the attachment region to the vehicle roof or the splash guard or to a rocker panel. The attachment can be produced by gluing, riveting, welding, brazing or similar coupling processes.

The region which has been partially heat-treated does not tend to tear or detach in the event of the accident and therefore holds the surrounding connected structural and safety-related components together. This is particular advantageous for a passenger compartment and hence for protecting occupants.

Another advantage occurs in regions subjected to an intentional deformation in the event of an accident. The regions designated for intentional deformation can deform without tearing. This increases the overall energy absorption capability of the entire motor vehicle chassis while limiting the penetration depth into the passenger compartment.

Another application is, for example, the intentional deformation of individual regions to lower the repair costs after an accident. This deformation is intended to transfer energy to be dissipated into the chassis, thereby once more improving the protection of vehicle occupants in the event of a crash.

The regions heat-treated with the method of the invention can be deformed in the event of a crash so as to produce intentional wrinkles accompanied by absorption of energy. Additionally, the heat-treated regions have a lesser tendency to form cracks due to their ductile structure compared to the hot-formed and press-hardened, hard and brittle structure.

The partial heat treatment of joining flanges has the additional advantage that the joining flanges have a ductile material characteristic. When a material connection is produced by thermal joining, a structural change takes place again in a subsequent process in the zone affected by heat generated by the joining method. A ductile section of the automobile column particularly advantageously affects the welding process and the material structure created in the zone affected by heat of the welding process. This is particularly advantageous for the durability of the connected weld seams of the motor vehicle in the event of an accident.

According to another advantageous feature of the present invention, openings in the automobile column may be partially heat-treated. These openings may be incorporated in the component, for example, to reduce weight or for passing through other components, for example a door hinge or a wiring harness and the like. Cracks may form in an accident particularly in the region of the openings and also in the end region of openings due to stress in the components, in particular surface stress, which may extend over the entire component. A ductile material structure is produced in this region by reducing the surface stress. This prevents crack formation and hence also impedes unintended deformation of the automobile column.

According to another advantageous feature of the present invention, an end region of the automobile column may be partially heat-treated, wherein a joining flange arranged on the end region is not heat-treated. Advantageously, by integrating the automobile column in a motor vehicle chassis, the heat-treated regions can attenuate loads from reverse bending stresses, which may be introduced into the chassis by, for example, chassis torsion or other driving parameters, for example drive train vibrations and the like. This has a beneficial effect particularly for the durability of the motor vehicle chassis by reducing the surface stress in the end regions, with the non-heat-treated joining flanges having particular benefits for attachment to the motor vehicle chassis with respect to the required crash properties.

According to another advantageous feature of the present invention, spot-shaped regions of the automobile column may be partially heat-treated, wherein the spot-shaped regions may have dimensions of less than 50 mm, suitably less than 30 mm. For attachment of the automobile column to a motor vehicle chassis, these spot-shaped regions may advantageously be intentionally heat-treated, thereby allowing spot welding or other local laser welding within the spot-shaped regions which are common in production processes of motor vehicles. In the event of a motor vehicle crash, the automobile column with the attached components again has high connection strength in these connected spot-shaped regions. Crack formation or tearing or tear-off is significantly reduced due to the heat-treated spot-shaped regions.

Advantageously, the heat-treated regions may have a yield strength between 300 N/mm² and 1300 N/mm², suitably 400 N/mm² to 800 N/mm². Currently preferred is a yield strength of 400 N/mm² to 600 N/mm². In addition, the heat-treated regions may have advantageously a tensile strength between 400 N/mm² and 1600 N/mm², suitably 500 N/mm² to 1000 N/mm². Currently preferred is a tensile strength of 550 N/mm² to 800 N/mm², and advantageously a ductility between 10% and 20%, and suitably 14% to 20%. The material still has the required high-strength mechanical properties; however, due to the reduced tensile strength, elongation limit and the increased ductility the material is sufficiently ductile to produce wrinkles, instead of breaking or tearing, under a suitable load. This advantageously counters potential crack formation in the heat-treated region of the material.

Advantageously, the yield strength and/or tensile strength may decrease in the transition zone from heat-treated region to non-heat-treated region with a gradient of more than 100 N/mm² per 1 cm, suiatbly of more than 200 N/mm² per 1 cm. Currently preferred is a gradient of more than 400 N/mm² per 1 cm. Advantageously, very small local regions may be heat-treated, whereas the transition zones are kept smaller in relation thereto. The transition zone resulting from the gradient between the hot-formed and press-hardened, non-heat-treated region and the partially heat-treated region may therefore have dimensions of less than 50 mm, suiatbly between 1 mm and 20 mm. This produces small locally heat-treated regions with sharp edges and smaller transition zones compared to the heat-treated regions.

In a particularly preferred embodiment, the automobile column may be partially heat-treated by heating the region to be heat-treated to a heat-up temperature, holding the heat-up temperature during a holding time, and cooling down from the heat-up temperature in at least two phases.

Advantageously, the component may be heated up to and held at the heat-up temperature in a temperature range between 500° C. and 900° C. The temperature range between 500° C. and 900° C. for heat-up and holding the heat-up temperature intentionally and reliably reduces stress in the heat-treated regions during production.

In a preferred embodiment, heat-up may occur over a time period of up to 30 seconds, suitably of up to 20 seconds. Currently preferred is a time period of up to 10 seconds, or of up to 5 seconds. The short heat-up phase for reaching the heat-up temperature is, in combination with a subsequent holding phase, particularly advantageous for the process reliability of the produced component.

According to another advantageous feature of the present invention, the holding time may extend over a time period of up to 30 seconds. Advantageously, the holding time may extend over a time period of up to 20 seconds, suitably of up to 10 seconds. Currently preferred is a holding time of up to 5 seconds. Within the context of the invention, hardening and tempering process can be particularly reliably performed by intentionally controlling the material structure transformation at a constant temperature and is only affected by the duration of the holding time. The attained heat-up temperature is held substantially constant during the holding time.

According to another advantageous feature of the present invention, the first cooldown phase may have a longer duration than the second cooldown phase. This is particularly advantageous for the material structure to be produced and for the related processing steps. The automobile column according to the invention can be post-processed immediately following processing. It is therefore feasible within the context of the invention that the heat-treated regions as well as the transmission tunnel have a component temperature of 200° C. when transferred to a post-processing process.

Moreover, the second phase may advantageously be performed in a time period of up to 120 seconds, suitably of up to 60 seconds.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a detail of an automobile column according to the invention;

FIG. 2 shows a perspective view of an A-column;

FIGS. 3a), b), c), show a perspective view of a B-column;

FIG. 4 shows a perspective view of a C-column;

FIG. 5 shows a perspective view of a D-column; and

FIGS. 6a), b), c) show different temperature curves in the manufacture of an automobile column.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

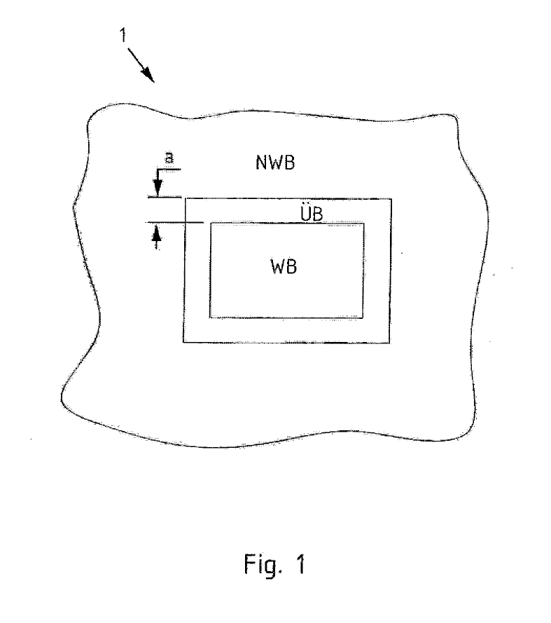

Turning now to the drawing, and in particular to FIG. 1, there is shown a detail of an automobile column 1. As can be seen, a heat-treated region WB is formed according to the present invention in a non-heat-treated region NWB. A transition zone UB is disposed between the non-heat-treated region NWB and the heat-treated region WB. A material structure with a tendency to be ductile is created in the heat-treated region WB, whereas the material structure in the non-heat-treated region NWB is hard and brittle. The transition zone UB is inherently created during treatment of the heat-treated region WB. In the context of the present invention, the transition zone UB between the heat-treated region WB to the non-heat-treated region NWB has essentially a width a, which is particularly small in relation to the heat-treated region WB and which has substantially sharp edges.

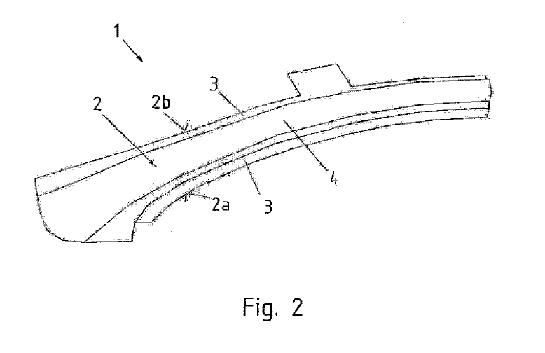

FIG. 2 shows an automobile column 1 in form of an A-column 2 of an unillustrated automobile chassis. Joining flanges 3 which are partially heat-treated are arranged on respective sides 2a, 2b of the A-column 2. The A-column 2 has, on one hand, high strength and hardness throughout its center profile section, which guarantees protection of a passenger compartment in the event of a crash and, on the other hand, a more ductile material characteristic at its joining flanges 3 compared to the center profile section, so that components attached to the joining flanges 3, which are not illustrated here in detail, remain attached to the A-column 2 without being torn off at the attachment points, which are defined by the joining flanges 3.

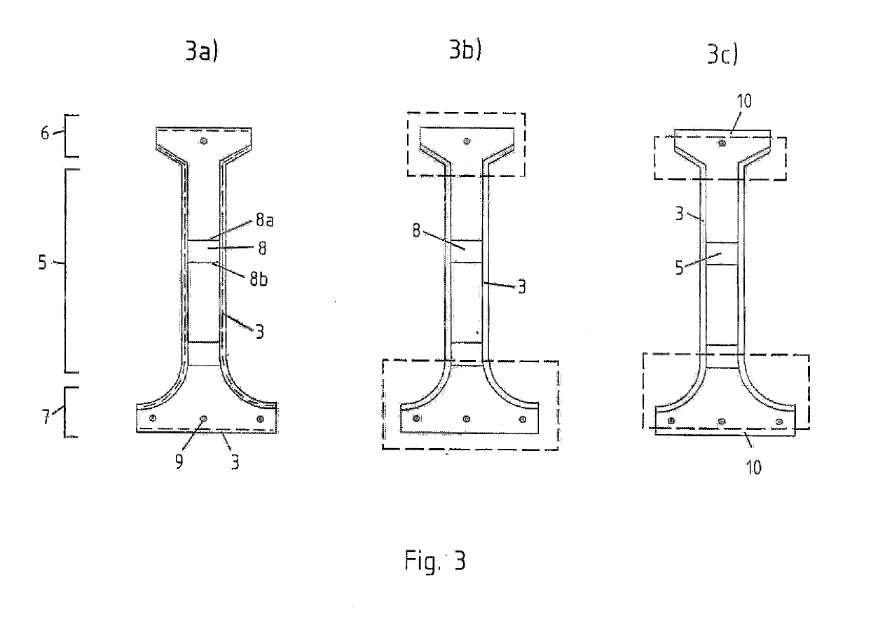

FIGS. 3a to 3c each shows a B-column 4 according to the invention with different regions which are heat-treated and not heat-treated.

FIG. 3a shows a B-column 4 with a center section 5, an upper section 6 and a lower-section 7. An exemplary recess 8 is formed in the center section 5, wherein the transition zones 8a, 8b of the recess 8 pointing towards the center section 5 are also partially heat-treated so as to enable targeted deformation.

As a result of the sharp edges of the transition zones 8a, 8b between the heat-treated region and the non-heat-treated region, a heat-treated recess 8 can be intentionally formed—as illustrated —, in order to attain a particularly advantageous effect for the entire vehicle chassis in the event of a vehicle crash.

The recess 8 is located in the region of attachment to an unillustrated door hinge. The heat-treated region in the recess 8 also prevents the hinge from being torn off in the event of a crash. The B-column 4 in FIG. 3a also has heat-treated joining flanges 3. These joining flanges 3 are provided in the center section 5 for attachment of additional components to the B-column 4 and in the upper section 6 for attachment of an unillustrated roof section and in the lower section 7 for connection to an unillustrated rocker panel.

Also illustrated are spot-shaped regions 9 which have also been heat-treated. A connection, for example by spot welding, can be provided in these spot-shaped regions 9 when the B-column 4 is installed in a vehicle chassis. With the intentional heat treatment in the spot-shaped region 9, which has a dimension between 1 mm and 50 mm, additional crash safety can be provided for the overall strength of the chassis, making it more difficult to tear the B-column 4, for example in the lower section 7, from the unillustrated rocker panel.

FIG. 3b shows a B-column 4 with a heat-treated upper section 6 and a heat-treated lower section 7. In this embodiment, the entire upper section 6 and the entire lower section 7 are heat-treated, thereby enabling ductile attachment to the unillustrated chassis across the entire region. It is here also particularly advantageous that, in the event of a vehicle crash, the B-column 4 is difficult to tear away from the chassis at the coupling locations. Moreover, the B-column 4 of FIG. 3b has joining flanges 3 which have also been heat-treated. It is also conceivable to attach unillustrated additional components at these joining flanges 3 which would be very difficult to tear off the B-column 4 in the event of an unintended deformation. Overall, the B-column 4 has a high stiffness and strength in the center section 5.

FIG. 3c shows another embodiment of a B-column 4, wherein the upper section 6 and the lower section 7 are heat-treated, in analogy to FIG. 2b, over the entire region. However, also shown is a non-heat-treated flange region 10 which projects over the upper section 6 end of the lower section 7, respectively. This is, for example, particularly advantageous for the connections in the event of a crash, because the heat-treated regions guarantee that the B-column 4 is securely attached to the chassis and that the flange regions 10 have a high stiffness, so that they have, in cooperation with the heat-treated regions, an optimized wrinkling characteristic when folding in a crash. As a result, a targeted dissipation of the crash energy is possible.

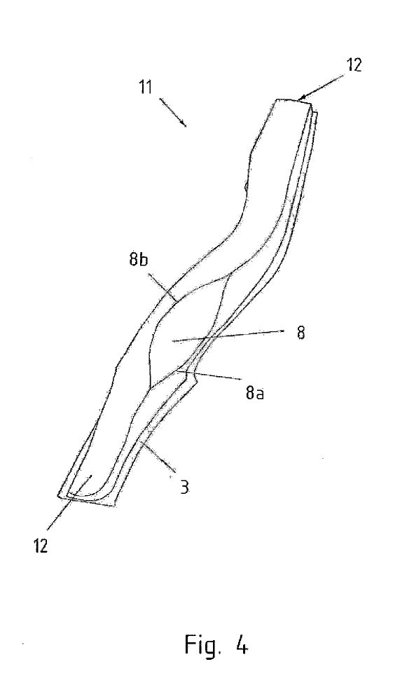

FIG. 4 shows a C-column 11 partially heat-treated according to the invention. The C-column 11 has likewise heat-treated joining flanges 3. The C-column 11 also has recesses 8 which are constructed to receive, for example, unillustrated door hinges. The recesses 8 can also be constructed to allow movable flaps or doors of the vehicle chassis to pivot.

The recess 8 may closely approach the joining flange 3 in the transition zones to the recess 8. By partially heat-treating the joining flange 3 and a very small unillustrated transition zone, the overall strength of the C-column 11 remains substantially unchanged, while simultaneously improving the tear-off and tear-out properties of attached components or of attachment points 12 on other chassis components.

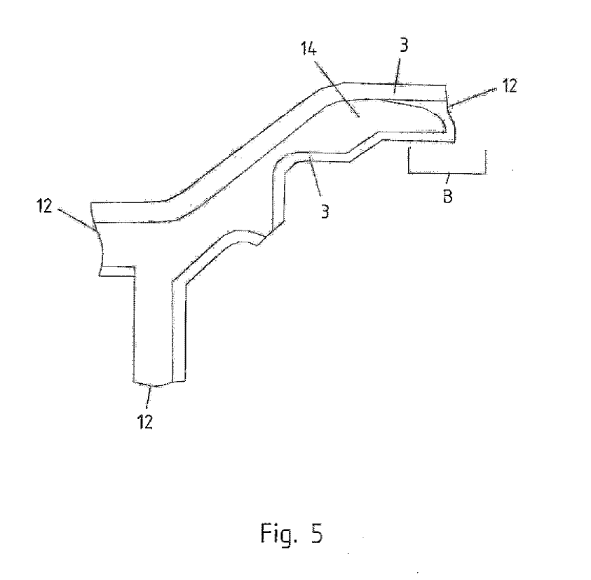

FIG. 5 shows a partially heat-treated D-column 13. This D-column 13 has likewise joining flanges 3 for attaching additional components and/or attachment points 12 for coupling to the vehicle chassis. Accordingly, several strength properties are set in the D-column 13.

In the illustrated application, a very ductile material property is required for the right (in relation to the drawing plane) attachment point 12 to the unillustrated vehicle chassis. A ductile material characteristic in this region is also required for the adjoining joining flanges 3, which simultaneously should provide a high deformation stiffness characteristic. Particularly hard and stiff material properties are required in a center section 14 of the D-column 13 so as to ensure a particularly torsion-resistant vehicle chassis in the event of a vehicle crash, for example in a rollover.

In the D-column 13 of the invention, the transition zones between joining flange 3, attachment points 12 to the vehicle chassis and center section 14 of the D-column 13 in the region B are designed to be quite small, so that different material properties relating to strength and crash safety are here combined in a small installation space.

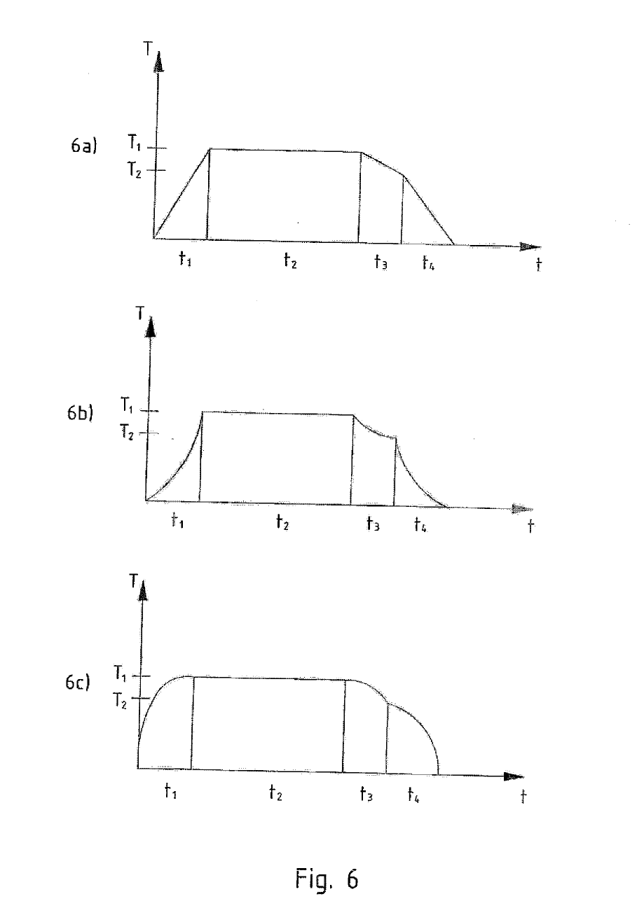

FIG. 6a shows a temperature curve as a function of time, with the time intervals heat-up time (t1), holding time (t2), cooldown time first phase (t3) and cooldown time second phase (t4). Also shown on the temperature axis are the heat-up temperature (T1) and a first cooldown temperature (T2).

Starting with a blank of sheet steel which is hot-formed and press-hardened to produce a transmission tunnel which is essentially at a temperature below 200° C., this vehicle component is heated during the heat-up time to the heat-up temperature (T1). With a starting temperature of below 200° C., but still above room temperature, the residual thermal energy from the hot-forming and press-hardening process is used for the partial heat treatment within the context of the invention.

Heat-up includes a linear temperature increase as a function of time. After the heat-up time (t1), the heat-up temperature (T1) is maintained during a holding time (t2). The heat-up temperature (T1) is held essentially constant during the entire holding time (t2). Temperature variations in form of a temperature increase or a temperature decrease are not illustrated, but may be implemented within the context of the invention during the holding time (t2) to affect the desired changes in the material structure, but also for cost reasons of the production process.

At the end of the holding time (t2), a first cooldown to a cooldown temperature (T2) occurs. The temperature hereby decreases linearly during the cooldown time of the first phase (t3) to the cooldown temperature (T2). The cooldown temperature (T2) may be in a range between 100° C. and the heat-up temperature (T1).

In an subsequent second cooldown phase, an additional linear temperature decrease takes place during the cooldown time of the second phase (t4). The temperature can hereby essentially be lowered to room temperature or to a desired (unillustrated) target temperature. It would also be feasible within the context of the invention to include additional cooldown phases, which are not illustrated.

FIG. 6b shows a substantially similar temporal arrangement of the heat treatment, with the difference to FIG. 6a that the temperature increases progressively during the heat-up time (t1), whereas the temperature steadily decreases with time (t3, t4) during the first and second phase of the cooldown.

FIG. 6c shows, in addition to FIGS. 6a and 6b, that the temperature curve has a diminishing temperature increase during the heat-up time (t1) and that the functional dependence of the temperature decrease over time (t3, t4) is progressive during each of the various cooldown phases.

In the context of the invention, it would also be feasible to combine the temperature dependence over time in mixed forms, such as progressive, linear and diminishing, and to realize a temperature change with progressive, diminishing or linear functional dependence during the holding time (t2).

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An automobile column made of sheet steel, said automobile column having a first region which underwent heat treatment, a second region which is not heat-treated, and a transition zone between the first and second regions, said transition zone defined by a width which is smaller than or equal to 50 mm.

2. The automobile column of claim 1, constructed as an A-column, a B-column, a C-column or a D-column.

3. The automobile column of claim 1, said automobile column produced by hot-forming and press-hardening of the steel sheet blank, said first region undergoing heat treatment after press-hardening.

4. The automobile column of claim 1, wherein the width of the transition zone is less than 30 mm.

5. The automobile column of claim 1, wherein the width of the transition zone is less than 20 mm.

6. The automobile column of claim 1, wherein the width of the transition zone corresponds to 0.2 times to 3.0 times a width and/or height of the first region.

7. The automobile column of claim 1, said automobile column comprising joining flanges having at least one region which is heat-treated.

8. The automobile column of claim 1, said automobile column comprising openings having at least one area which is heat-treated.

9. The automobile column of claim 1, said automobile column comprising recesses having at least one area which is heat-treated.

10. The automobile column of claim 1, wherein the first region of the automobile column is an end region, said automobile column having a joining flange arranged on the end region and constituting the second region.

11. The automobile column of claim 1, wherein the first region has spot-shaped zones defined by a size which is less than 50 mm.

12. The automobile column of claim 1, wherein the first region has spot-shaped zones defined by a size which is less than 30 mm.

13. The automobile column of claim 1, wherein the first region is defined by a yield strength between 300 N/mm² and 1300 N/mm² .

14. The automobile column of claim 1, wherein the first region is defined by a yield strength from 400 N/mm² to 800 N/mm².

15. The automobile column of claim 1, wherein the first region is defined by a yield strength from 400 N/mm² to 600 N/mm² .

16. The automobile column of claim 1, wherein the first region is defined by a tensile strength between 400 N/mm² and 1600 N/mm².

17. The automobile column of claim 1, wherein the first region is defined by a tensile strength from 500 N/mm² to 1000 N/mm².

18. The automobile column of claim 1, wherein the first region is defined by a tensile strength from 550 N/mm² to 800 N/mm².

19. The automobile column of claim 1, wherein the first region is defined by a ductility between 10% and 20%.

20. The automobile column of claim 1, wherein the first region is defined by a ductility from 14% to 20%.

21. The automobile column of claim 1, wherein the transition zone is defined by a yield strength and/or tensile strength decreasing with a gradient of more than 100 N/mm² per 1 cm.

22. The automobile column of claim 1, wherein the transition zone is defined by a yield strength and/or tensile strength decreasing with a gradient of more than 200 N/mm² per 1 cm.

23. The automobile column of claim 1, wherein the transition zone is defined by a yield strength and/or tensile strength decreasing with a gradient of more than 400 N/mm² per 1 cm.

24. The automobile column of claim 3, wherein the heat treatment of the first region includes heating to a heat-up temperature, holding the heat-up temperature during a holding time, and cooling down from the heat-up temperature in at least two phases.

25. The automobile column of claim 24, wherein the heat-up temperature ranges between 500° C. and 900° C.

26. The automobile column of claim 24, wherein the first region is heated to the heat-up temperature at a time interval of up to 30 seconds.

27. The automobile column of claim 24, wherein the first region is heated to the heat-up temperature at a time interval of up to 20 seconds.

28. The automobile column of claim 24, wherein the first region is heated to the heat-up temperature at a time interval of up to 10 seconds.

29. The automobile column of claim 24, wherein the first region is heated to the heat-up temperature at a time interval of up to 5 seconds.

30. The automobile column of claim 24, wherein the holding time is up to 30 seconds.

31. The automobile column of claim 24, wherein the holding time is up to 20 seconds.

32. The automobile column of claim 24, wherein the holding time is up to 10 seconds.

33. The automobile column of claim 24, wherein the holding time is up to 5 seconds.

34. The automobile column of claim 24, wherein a first phase of the two cooldown phases has a duration which is longer than a duration of a second phase of the two cooldown phases.

35. The automobile column of claim 34, wherein the duration of the second phase is up to 120 seconds.

36. The automobile column of claim 34, wherein the duration of the second phase is up to 60 seconds.
